(19) United States
(12) Patent Application Publication
(10) Pub. No.: US 2009/0207927 A1
(43) Pub. Date: Aug. 20, 2009

(54) RECEIVING APPARATUS

(76) Inventors: Kouya Watanabe, Osaka (JP); Kengo Fukuda, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/300,888

(22) PCT Filed: Dec. 26, 2006
(86) PCT No.: PCT/JP2006/325876

§ 371 Date: Nov. 14, 2008

(51) Int. Cl. H04K 1/10; H04L 27/06

(52) U.S. Cl. 375/260; 375/344

(57) ABSTRACT

There is provided a receiving apparatus (1) that comprises; a receiving unit (4) for receiving a frequency division multiplexing signal to output a receiving signal; a first demodulating unit (7) for demodulating a receiving signal based on 1 segment broadcasting and 3 segment broadcasting to output a first carrier; a second demodulating unit (8) for demodulating a receiving signal based on the 1 segment broadcasting to output a second carrier; a judging unit (9) for judging whether a receiving signal is the 1 segment broadcasting or the 3 segment broadcasting; and a combining/selecting unit (10) for combining or selecting the first carrier and the second carrier. In case of the 1 segment broadcasting, the combining/selecting unit (10) combines or selects the first carrier and the second carrier. In case of the 3 segment broadcasting, the combining/selecting unit (10) selects the first carrier.

### TECHNICAL FIELD

The present invention relates to a receiving apparatus operable to receive a frequency division multiplexing signal, particularly an orthogonal frequency division multiplexing signal (hereinafter, it is called as an “OFDM signal”) used for digital terrestrial television services.

### BACKGROUND ART

In Japan, the digital terrestrial television services have started since 2003 according to the ISDB-T standard. The OFDM signal is used in the ISDB-T standard. Moreover, in the ISDB-T standard, one bandwidth is divided into 13 segments, and the 13 segments are used hierarchically. Thus, various broadcast services can be realized.

In the hierarchical use of the segments, for a mobile object and a mobile terminal, 1 segment broadcasting using 1 segment out of the 13 segments and 3 segment broadcasting using 3 segments out of the 13 segments are planned.

It is required that the 1 segment broadcasting and the 3 segment broadcasting are receivable under the poor environment in mobile reception. In a receiving apparatus corresponding to the 1 segment broadcasting and the 3 segment broadcasting, in order to improve quality of reception, diversity receiving in a carrier unit, which can be acquired by performing the frequency conversion to an OFDM signal, is effective (for example, See Document 1).

However, since services both of the 1 segment broadcasting and the 3 segment broadcasting are considered for the terminal object and the mobile terminal, the receiving apparatus needs to receive both of the services. When the diversity receiving in a carrier unit is performed at this point, the number of elements from receiving the signal to performing the time-to-frequency conversion to the received signal needs to correspond to the number of branches (a branch indicates the reception series on the basis of the antenna in diversity receiving).

In all branches, when an element for corresponding to both of the 1 segment broadcasting and the 3 segment broadcasting is provided, the circuit scale increases. Thus, it causes increases of power consumption and manufacture cost. The 3 segment broadcasting possesses three times as many carriers as the 1 segment broadcasting does. It is because the corresponding circuit also increases according thereto.

On the other hand, when the diversity in a carrier unit is not performed in order to suppress the increase of the circuit scale, it deteriorates the quality of reception. In particular, in the 1 segment broadcasting, the deterioration of the quality of reception is remarkable.

[Document 1] Published Japanese patent Application Laid-open on No. 2006-41980

### DISCLOSURE OF INVENTION

### Problem(s) to be Solved by Invention

In view of the above, an object of the present invention is to provide a receiving apparatus capable of establishing both of the diversity receiving in a carrier unit with respect to the 1 segment broadcasting, and the non-diversity receiving with respect to the 3 segment broadcasting without causing increase of the circuit scale.

### Means for Solving Problem(s)

A first aspect of the present invention provides a receiving apparatus comprising: a receiving unit operable to receive a frequency division multiplexing signal to output a receiving signal; a first demodulating unit operable to demodulate the receiving signal based on one of 1 segment broadcasting and 3 segment broadcasting to output a first carrier group; a second demodulating unit operable to demodulate the receiving signal based on the 1 segment broadcasting to output a second carrier group; a judging unit operable to judge one of a first judgment result and a second judgment result, the first judgment result indicating that the receiving signal includes the frequency division multiplexing signal based on the 1 segment broadcasting, the second judgment result indicating that the receiving signal includes the frequency division multiplexing signal based on the 3 segment broadcasting; and a combining/selecting unit operable to perform at least one of combining the first carrier group with the second carrier group, and selecting one of the first carrier group and the second carrier group, wherein in case of the first judgment result, the combining/selecting unit performs one of combining the first carrier group with the second carrier group then outputting a combined carrier, and selecting one of the first carrier group and the second carrier group then outputting a selected carrier, and wherein in case of the second judgment result, the combining/selecting unit performs selecting the first carrier group.

With this arrangement, the diversity receiving that improves quality of reception is performed when receiving the 1 segment broadcasting, and the non-diversity receiving of the 3 segment broadcasting with small circuit scale and less power consumption when receiving the 3 segment broadcasting. That is, it is possible to establish the diversity receiving with respect to both of the 1 segment broadcasting and the 3 segment broadcasting without causing increase of the circuit scale and power consumption.

A second aspect of the present invention provides a receiving apparatus defined in the first aspect, wherein the judging unit performs judgment based on an instruction signal from the exterior.

A third aspect of the present invention provides a receiving apparatus as defined in the first aspect, wherein the judging unit performs judgment based on a TMCC signal demodulated by at least one of the first demodulating unit and the second demodulating unit.

These arrangements enable to easily judge whether an OFDM signal being received is based on the 1 segment broadcasting or the 3 segment broadcasting.

A fourth aspect of the present invention provides a receiving apparatus defined in the first aspect, wherein the judging unit output a judgment result to the exterior.

This arrangement enables to stop power supply to a tuner or the receiving unit according to the judgment result, thereby performing control for reducing power consumption.

A fifth aspect of the present invention provides a receiving apparatus defined in the first aspect, wherein the combining/selecting unit combines the first carrier group with the second carrier group, in maximum ratio according to a predetermined reference value. This arrangement enables to improve quality of reception when receiving the 1 segment broadcasting.

A sixth aspect of the present invention provides a receiving apparatus defined in the first aspect, wherein at least one of the first demodulating unit and the second demodulating unit comprises: an analog-to-digital converter operable to digitize the receiving signal; a wave detecting unit operable to detect a signal outputted by the analog-to-digital converter; and a time-to-frequency mapping unit operable to map a signal outputted by the wave detecting unit from a signal along a time axis to a signal along a frequency axis.

This arrangement enables to perform demodulation corresponding to both of the 1 segment broadcasting and the 3 segment broadcasting with the least circuit scale.

A seventh aspect of the present invention provides a receiving apparatus comprising: a receiving unit operable to receive a frequency division multiplexing signal to output a receiving signal; a first demodulating unit operable to demodulate the receiving signal based on 1 segment broadcasting to output a first carrier group; a second demodulating unit operable to demodulate the receiving signal based on the 1 segment broadcasting to output a second carrier group; a judging unit operable to judge one of a first judgment result and a second judgment result, the first judgment result indicating that the receiving signal includes the frequency division multiplexing signal based on the 1 segment broadcasting, the second judgment result indicating that the receiving signal includes the frequency division multiplexing signal based on 3 segment broadcasting; a combining/selecting unit operable to perform at least one of combining the first carrier group with the second carrier group, and selecting one of the first carrier group and the second carries group; and an error correcting unit operable to perform error correction with respect to a signal outputted by the combining/selecting unit, wherein in case of the first judgment result, the first demodulating unit and the second demodulating unit demodulates the receiving signal based on the 1 segment broadcasting, respectively, and the combining/selecting unit performs one of combining the first carrier group with the second carrier group then outputting a combined carrier, and selecting one of the first carrier group and the second carries group then outputting selected carrier, and wherein in case of the second judgment result, the first demodulating unit demodulates the receiving signal based on the 3 segment broadcasting with the use of the second demodulating unit.

With this arrangement, the diversity receiving that improves quality of reception is performed when receiving the 1 segment broadcasting, and the non-diversity receiving of the 3 segment broadcasting with the least circuit scale and less power consumption when receiving the 3 segment broadcasting. That is, it is possible to establish the diversity receiving with respect to both of the 1 segment broadcasting and the 3 segment broadcasting without causing increase of the circuit scale and power consumption.

An eighth aspect of the present invention provides a receiving apparatus as defined the seventh aspect, wherein each of the first demodulating unit and the second demodulating unit comprises: an analog-to-digital converter operable to digitize the receiving signal; a wave detecting unit operable to detect a signal outputted by the analog-to-digital converter; and a time-to-frequency mapping unit operable to map a signal outputted by the wave detecting unit from a signal along a time axis into a signal along a frequency axis, wherein the time-to-frequency mapping unit possesses sampling numbers not less than the product of one point five and sampling numbers necessary for 1 segment broadcasting, wherein, when the judging unit judges that the receiving signal is the frequency division multiplexing signal based ion the 3 segment broadcasting, the first demodulating unit demodulates the receiving signal based on the 3 segment broadcasting, with the use of the time-to-frequency converting unit possessed by the second demodulating unit.

A ninth aspect of the present invention provides a receiving apparatus as defined in the seventh aspect, wherein in case of the second judgment result, the first demodulating unit demodulates the receiving signal based on the 3 segment broadcasting, with the use of the analog-to-digital converter possessed by the second demodulating unit.

A tenth aspect of the present invention provides a receiving apparatus as defined in the seventh aspect, wherein the error correcting unit comprises a storing unit, and wherein in case of the second judgment result, the first demodulating unit demodulates the receiving signal based on the 3 segment broadcasting, with the use of the storing unit possessed by the error correcting unit.

An eleventh aspect of the present invention provides a receiving apparatus as defined in the seventh aspect, wherein the second demodulating unit comprises a storing unit, and wherein in case of the second judgment result, the first demodulating unit demodulates the receiving signal based on the 3 segment broadcasting, with the use of the storing unit possessed by the second demodulating unit.

A twelfth aspect of the present invention provides a receiving apparatus as defined in the seventh aspect, further comprising: a third demodulating unit operable to demodulate the receiving signal based on the 3 segment broadcasting to output a third carrier group, wherein in case of the first judgment result, the first demodulating unit, second demodulating unit, and third demodulating unit demodulates the receiving signal based on the 1 segment broadcasting, respectively, and the combining/selecting unit combines the first carrier group, the second carrier group, and the third carrier group then outputs a combined carrier, and wherein in case of the second judgment result, the first demodulating unit demodulates the receiving signal based on the 3 segment broadcasting, with the use of the second demodulating unit and the third demodulating unit.

With these arrangements, the diversity receiving that improves quality of reception is performed when receiving the 1 segment broadcasting, and the non-diversity receiving of the 3 segment broadcasting with the least circuit scale and less power consumption when receiving the 3 segment broadcasting. That is, it is possible to establish the diversity receiving with respect to both of the 1 segment broadcasting and the 3 segment broadcasting without causing increase of the circuit scale and power consumption. Especially, making the most of the plurality of demodulating units that can demodulate an OFDM signal of the 1 segment broadcasting to demodulate an OFDM signal of the 3 segment broadcasting without causing increase of the circuit scale.

### EFFECT OF INVENTION

According to the present invention, without causing unnecessary increase of the circuit scale, it is possible to establish both of the diversity receiving with respect to the 1 segment broadcasting and the non-diversity receiving with respect to the 3 segment broadcasting.

In other words, for the 1 segment broadcasting that easily comes under the influence of the receiving environment, the diversity receiving, which improves the quality of reception, can be realized. For the 3 segment broadcasting that comes under the influence of the receiving environment less than the 1 segment broadcasting, the non-diversity receiving is performed. Thus, it is possible to suppress the increase of the circuit scale.

When the 3 segment broadcasting is used, it is possible to realize the non-diversity receiving of the 3 segment broadcasting by using the resource which the receiving apparatus possesses effectively, while not providing additional circuits.

### BRIEF DESCRIPTION OF DRAWINGS

FIG. 1 is a block diagram of a receiving apparatus according to Embodiment 1 of the present invention;

FIG. 2 indicates explanation of combining in maximum ratio according to Embodiment 1 of the present invention.

FIG. 3 is a block diagram of a receiving apparatus according to Embodiment 2 of the present invention;

FIG. 4 is a block diagram of the receiving apparatus according to Embodiment 2 of the present invention;

FIG. 5 is a block diagram illustrating neighborhood of FFT according to Embodiment 2 of the present invention;

FIG. 6 is a block diagram illustrating neighborhood of a analog-to-digital converter according to Embodiment 2 of the present invention; and

FIG. 7 is a timing chart explaining analog-to-digital conversion according to Embodiment 2 of the present invention.

### DESCRIPTION OF SYMBOLS

1: Receiving apparatus
2, 3: Antenna
4: Receiving unit
5, 6: Tuner
7: First demodulating unit
8: Second Demodulating Unit
9: Judging unit
10: Combining/selecting unit
11: Error correcting unit

### THE MODE FOR CARRYING OUT THE INVENTION

Hereafter, referring to the accompanying drawings, preferred embodiments of the present invention will be explained.

### Embodiment 1

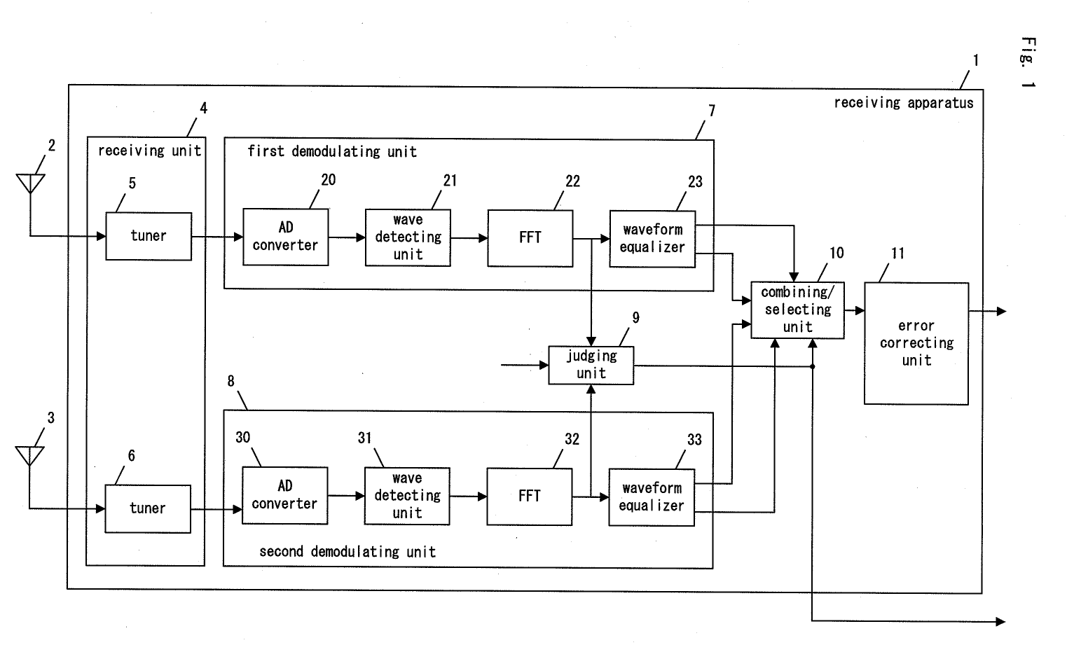

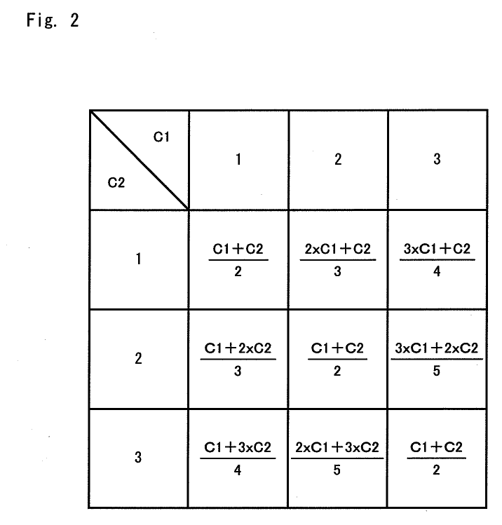

Referring to FIGS. 1 and 2, Embodiment 1 will now be explained.

FIG. 1 is a block diagram of a receiving apparatus according to Embodiment 1 of the present invention.

A receiving apparatus 1 is provided with: a receiving unit 4 operable to receive a frequency division multiplexing signal and to output a receiving signal; a first demodulating unit 7; a second demodulating unit 8; a judging unit 9; a combining/selecting unit 10; and an error correcting unit 11.

Moreover, antennas 2 and 3 are connected to the receiving unit 4.

Each element will now be explained first.

In addition, the frequency division multiplexing signal broadly includes a communication signal for which a carrier is multiplexed on a frequency axis. In Embodiment 1, an OFDM signal, which is defined by the ISDB-T standard in digital terrestrial television services of Japan, will now be explained as an example. In addition, not only the OFDM signal, but the communication signal also may broadly include an FDM signal, an SS-OFDM signal, and so on.

Moreover, in the ISDB-T standard in the digital terrestrial television services, 13 segments form one bandwidth by making one segment, which consists of a predetermined number of carrier groups, as a unit. Within this description, in the ISDB-T standard, the 1 segment broadcasting means the broadcasting using one segment of the 13 segments for a mobile terminal. Similarly, the 3 segment broadcasting means the broadcasting using three segments of the same 13 segments.

(Antenna)

The antennas 2 and 3 receive the OFDM signal. The number of the antennas 2 and 3 corresponds to the number of demodulating units. In FIG. 1, there are two demodulating units, the first demodulating unit 7 and the second demodulating unit 8; thus, two antennas of the antennas 2 and 3 are provided.

(Tuner)

A tuner 4 is connected to the antenna 2. A tuner 6 is connected to the antenna 3. In Embodiment 1, the first demodulating unit 7 can demodulate both of the 1 segment broadcasting and the 3 segment broadcasting. On the other hand, the second demodulating unit 8 can demodulate the 1 segment broadcasting. For this reason, the tuner 5 connected to the first demodulating unit 7 performs reception corresponding to the 1 segment broadcasting and the 1 segment broadcasting. The tuner 6 connected to the second demodulating unit 8 performs reception corresponding to the 1 segment broadcasting. Based on center frequency according to a broadcasting bandwidth, both tuners select and receive a specific bandwidth of the OFDM signal received by the antennas 2 and 3.

The tuner 5 and the tuner 6 output the received OFDM signal to the first demodulating unit 7 and the second demodulating unit as a receiving signal.

(Analog-to-Digital Converter)

The first demodulating unit 7 and the second demodulating unit 8 are provided with analog-to-digital converters (in the figure, it is written as an “AD converter”) 20 and 30, respectively.

The analog-to-digital converter 20 converts the receiving signal from the tuner 5 into a digital signal from an analog signal. Similarly, an analog-to-digital converter 30 converts the receiving signal from a tuner 6 into a digital signal from an analog signal. The analog-to-digital converters 20 and 30 possess resolution according to the specification of the receiving apparatus 1.

The analog-to-digital converters 20 and 30 output the converted digital signal to wave detecting units 21 and 31, respectively.

(Wave Detecting Unit)

Each of the first demodulating unit 7 and the second demodulating unit 8 is provided with the wave detecting units 21 and 31.

The wave detecting units 21 and 31 detect the receiving signal converted into the digital signal in synchronous processing. The wave detecting units 21 and 31 output the detected signal to FFTs 22 and 32.

The wave detecting units 21 and 31 detect the receiving signal according to synchronous detection or delay detection.

(FFT)

Each of the first demodulating unit 7 and the second demodulating unit 8 is provided with a fast Fourier transforming unit (hereinafter and in figures, it is called as “FFT”). Each of the FFTs 22 and 32 is an example of a time-to-frequency converting unit that converts the outputs of the wave detecting units 21 and 31 to the signal of the frequency axis from the signal of the time axis. As long as the FFTs 22 and 32 possess the function of converting the signal of the time axis to the signal of the frequency axis, they can be the time-to-frequency converting unit that uses fractal.

The FFT 22 demodulates a carrier group, which is multiplexed on the frequency axis by converting the receiving signal in the first demodulating unit 7 into the signal of the frequency axis from the time axis. Here, the carrier group which is demodulated by the FFT 22 is called as a first carrier group. The first carrier group includes a plurality of carriers. Each of the plurality of carriers are orthogonalized and multiplexed mutually.

The first carrier group corresponds to the OFDM signal in the ISDB-T standard, and includes a data carrier, a pilot carrier, and a transmission control carrier.

The FFT 22 outputs the demodulated first carrier group to a waveform equalizer 23 and the judging unit 9. In addition, each of the first carriers includes a modulated digital data.

The FFT 32 demodulates a carrier group, which is multiplexed on the frequency axis, by converting the receiving signal in the second demodulating unit 8 to the signal of the frequency axis from the time axis. Here, the carrier group, which is demodulated by the FFT 32, is called as a second carrier group. The second carrier group includes a plurality of carriers. Each of the carriers is orthogonalized and multiplexed mutually.

Similar to the first carrier group, the second carrier group corresponds to the OFDM signal in the ISDB-T standard, and includes a data carrier, a pilot carrier, and a transmission control carrier.

The FFT 32 outputs the demodulated second carrier group to a waveform equalizer 33 and the judging unit 9.

In addition, since the FFTs 22 and 32 perform time-to-frequency conversion in response to the outputs of the wave detecting units 21 and 31, it is preferable that each of the FFTs 22 and 32 possesses a function of adjusting a range to be extracted (window position).

In addition, since the first demodulating unit 7 corresponds to both of the 1 segment broadcasting and the 3 segment broadcasting, the FFT 22 is provided with a number of sampling points corresponding to the number of carriers used by the 3 segment broadcasting. On the other hand, since the second demodulating unit 8 corresponds to the 1 segment broadcasting, the FFT 32 is provided with a number of sampling points corresponding to a number of carriers used by 1 segment broadcasting. For this reason, comparing to the FFT 22, the FFT 32 possesses a smaller circuit scale.

(Waveform Equalizer)

Each of the first demodulating unit 7 and the second demodulating unit 8 is provided with waveform equalizers 23 and 33, respectively.

The waveform equalizer 23 receives the first carrier group, performs phase control of a data carrier based on a pilot carrier included in the first carrier group, and calculates a reliability value of the data carrier as well.

The pilot carrier is a carrier that possesses a given or known amplitude and phase. In the waveform equalizer 23, the received pilot carrier is divided in complex number by the given or known pilot carrier. Thus, a shift amount of the amplitude and the phase of the received pilot carrier are calculated. A channel characteristic is presumed from this shift amount.

Based on this presumed channel characteristic, the waveform equalizer 23 adjusts the amplitude and phase of the data carrier, which is included in the first carrier group modulated by the FFT 22. Thus, the quality of demodulation is improved. Moreover, the waveform equalizer 23 calculates the reliability value used by the combining/selecting unit 10 that will be described in the following.

The waveform equalizer 23 outputs the first carrier group, which has adjusted the amplitude and the phase, and the calculated reliability value to the combining/selecting unit 10.

The waveform equalizer 33 included in the second demodulating unit 8 also possesses the same function as the waveform equalizer 23, and performs the same processing.

For the same reason as the difference between the FFT 22 and the FFT 32, comparing to the waveform equalizer 23, the waveform equalizer 33 possesses the smaller circuit scale.

As mentioned above, the first demodulating unit 7 needs to correspond to the 3 segment broadcasting in addition to the 1 segment broadcasting. However, since the second demodulating unit 8 corresponds to the demodulation of the 1 segment broadcasting, the second demodulating unit 8 possesses smaller circuit scale comparing to the first demodulating unit 7.

(Judging Unit)

The judging unit 9 judges whether the receiving signal, which the receiving apparatus 1 is receiving, includes the OFDM signal based on the 1 segment broadcasting, or the receiving signal includes the OFDM signal based on the 3 segment broadcasting. Here, when the receiving signal includes the OFDM signal based on the 1 segment broadcasting, the judging unit 9 judges that it is a first judgment result. When the receiving signal includes the OFDM signal based on the 3 segment broadcasting, the judging unit 9 judges that it is a second judgment result.

Each of the 1 segment broadcasting and the 3 segment broadcasting is a form of broadcasting for a mobile terminal or a portable terminal in the ISDB-T standard. A broadcasting station and a broadcasting system decide which broadcasting of the 1 segment broadcasting and 3 segment broadcasting should be performed. For this reason, in order to deal with the change of the broadcasting system, the receiving apparatus 1 needs to receive both of the 1 segment broadcasting and the 3 segment broadcasting. For this reason, the receiving apparatus 1 may receive the OFDM signal of the 1 segment broadcasting, and may receive the OFDM signal of the 3 segment broadcasting.

The judging unit 9 judges whether the OFDM signal being received is the 1 segment broadcasting or the 3 segment broadcasting.

The judging unit 9 performs classification judgment of the 1 segment broadcasting and the 3 segment broadcasting using a TMCC signal, which is modulated by at least one of the first demodulating unit 7 and the second demodulating unit 8. The TMCC signal can be acquired by modulation of a transmission control carrier included in the first carrier group or the second carrier group. The TMCC signal includes transmission information of an item, such as a modulating method and an error correcting method. The transmission information also includes information indicating a broadcasting format (in other words, the classification of the 1 segment broadcasting and the 3 segment broadcasting). For this reason, the judging unit 9 judges whether the receiving signal is the 1 segment broadcasting or the 3 segment broadcasting according to the demodulated TMCC signal.

Alternatively, the judging unit 9 may judge the classification of the 1 segment broadcasting and the 3 segment broadcasting using an instruction signal from the outside of the receiving apparatus 1. The instruction signal from the outside may occur, for example, when a user pushes a button provided with the receiving apparatus or selects an item of a displayed menu.

The judging unit 9 outputs the judgment result to the combining/selecting unit 10, the first demodulating unit 7, and the second demodulating unit 8. If needed, the judging unit 9 outputs the judgment result to the outside of the receiving apparatus 1 as well. For example, in order to display the judgment result on the display apparatus provided with the mobile terminal or the portable terminal including the receiving apparatus 1, the judgment result is outputted to the control unit of the display apparatus.

(Combining/Selecting Unit)

The combining/selecting unit 10 selects or combines the first carrier group and the second carrier group using the reliability value (it is one of the predetermined reference values) outputted from the waveform equalizers 23 and 33.

According to an instruction that is set, the combining/selecting unit 10 determines whether it should select or combine them. The setting is performed by setting one or more registers according to a program executed on a CPU, or the like.

First, a case of selecting will now be explained.

The first demodulating unit 7 outputs the first carrier group. The second demodulating unit 8 outputs the second carrier group. Then, the carrier groups are inputted into the combining/selecting unit 10. Similarly, the first reliability value to the carrier of the first carrier group and the second reliability value to the carrier of the second carrier group are also inputted into the combining/selecting unit 10. The combining/selecting unit 10 compares the first reliability value to the arbitrary carrier included in the first carrier group, and the second reliability value to the carrier of the second carrier group corresponding thereto (the carrier position in the frequency axis is the same). The combining/selecting unit 10 selects the carrier whose value is larger (if the larger the value is, the higher reliability is meant), and then outputs the value.

Next, a case of combining will now be explained.

The combining/selecting unit 10 performs the combining in maximum ratio to the carrier included in the first carrier group and the carrier included in the second carrier group that corresponds thereto, based on the reliability value. The combining in maximum ratio means calculating the average according to the reliable value, and combining the carriers of the first carrier group and the second carrier group.

It will now be explained referring to FIG. 2. FIG. 2 indicates explanation of combining in maximum ratio according to Embodiment 1 of the present invention.

In FIG. 2, the reliability value has three steps of values from a value of “1” to a value of “3”. A larger reliability value means higher reliability. In other words, the reliability value of “3” has higher reliability than the reliability value of “1”. Moreover, the carrier included in the first carrier group is “C1”, and the carrier included in the second carrier group is “C2”.

The top row shows the reliability value of the carrier “C1”, and the leftmost column shows the reliability value of the carrier “C2.”

As shown in FIG. 2, the combining/selecting unit 10 calculates the combining in maximum ratio based on the reliability value, and outputs the result.

For example, when the reliability value of a carrier “C1” is a value of “2” and the reliability value of a carrier “C2” is a value of “1”, the combining/selecting unit 10 performs the calculation according to the equation of ((2*C1)+C2)/3, and outputs it. When reliability values differ, it is as indicated in FIG. 2.

Moreover, in addition to the combining in maximum ratio, the combining/selecting unit 10 may perform combining in equal ratio, which is combining the carriers included in the first carrier group and the second carrier group at a fixed ratio.

In addition, the combining/selecting unit 10 performs selecting and combining for every carrier.

Since the combining/selecting unit 10 performs selecting and combining for every carrier, the quality of demodulation improves, and a bit error rate decreases. Thus, the quality of reception improves.

The combining/selecting unit 10 outputs the result of selecting and/or combining to the error correcting unit 11.

(Error Correcting Unit)

The error correcting unit 11 corrects an error of the digital data included in a modulated carrier or a carrier.

The error correcting unit 11 performs Viterbi decoding, Reed-Solomon decoding, etc., and detects and corrects the error of a carrier or data. The digital data, by which the error correction is performed, is outputted as packet data regarding an image and/or an audio. Necessary decoding is performed to the packet data. Then, it is reproduced as the image and/or the audio. The receiving apparatus 1 is provided with a display and/or a speaker if needed. Users can see and listen to the reproduced image and/or audio.

Next, operation of the receiving apparatus 1 in the 1 segment broadcasting and operation of the receiving apparatus 1 in the 3 segment broadcasting are explained.

(At the Time of 1 Segment Broadcasting)

When the judging unit 9 judges that the received OFDM signal is the signal based on the 1 segment broadcasting, the receiving apparatus 1 performs receiving processing corresponding to the 1 segment broadcasting. Specifically, the receiving apparatus 1 performs the diversity receiving using two branches of the first demodulating unit 7 and the second demodulating unit 8. The judging unit 9 outputs the instruction, which indicates it is the 1 segment broadcasting, to the combining/selecting unit 10, the first demodulating unit 7, and the second demodulating unit 8.

In each of the first demodulating unit 7 and the second demodulating unit 8, the OFDM signal, which is received by the antenna 2 and the antenna 3, is demodulated in order to correspond to the 1 segment broadcasting. The first carrier group, the second carrier group, the first reliability value, and the second reliability value are outputted. The demodulating processing in the first demodulating unit 7 and the second demodulating unit 8 is the same as explained referring to FIG. 1.

Using the first carrier group from the first demodulating unit 7 and the second carrier group from the second demodulating unit 8, the combining/selecting unit 10 performs selecting or combining, and then outputs a result to the error correcting unit 11. The selecting and combining is the same as above-explained referring to FIGS. 1 and 2.

Thus, when the OFDM signal to be received is the 1 segment broadcasting, the receiving apparatus 1 in Embodiment 1 is demodulated by the first demodulating unit 7 corresponding to both of the 1 segment broadcasting and the 3 segment broadcasting, and also demodulated by the second demodulating unit 8 corresponding to the 1 segment broadcasting, independently. Thereby, the combining/selecting unit 10 performs the diversity receiving.

As a result, when the 1 segment broadcasting is performed, it is possible to improve quality of reception by the receiving apparatus 1 also capable of receiving the 3 segment broadcasting.

The receiving apparatus 1 may be provided with a third demodulating unit operable to demodulate the 1 segment broadcasting at least, in addition to the first demodulating unit 7 and the second demodulating unit 8. The receiving apparatus 1 may perform the diversity receiving by using the demodulation result, which is larger than 3, at the time of the 1 segment broadcasting (of course, it may be provided with a demodulating unit that is larger than 4, and it is not limited). When a number of branches increases, it is possible to further improve the quality of reception by diversity receiving.

Moreover, in some of the demodulating units, when the quality of reception is extremely poor, in the diversity receiving, if the combining/selecting unit 10 does not use the carrier from the concerned receiving unit, it is possible to prevent deterioration of the quality of reception. At this time, when the supply of a clock signal to the demodulating unit whose quality of reception is extremely poor is stopped or the electric power supply is stopped, it is possible to reduce the power consumption.

(At the Time of 3 Segment Broadcasting)

When the judging unit 9 judges that the received OFDM signal is an OFDM signal based on the 3 segment broadcasting, the combining/selecting unit 10 selects only first carrier group which is the output of the first demodulating unit 7, and outputs it to the error correcting unit 11.

In case of the 3 segment broadcasting, in the second demodulating unit 8, demodulating processing corresponding to the 3 segment broadcasting can not be performed. Thus, the combining/selecting unit 10 selects only the output from the first demodulating unit 7 operable to perform demodulating processing, which corresponds to the 3 segment broadcasting. The output is used for data demodulating later on.

In addition, when the judging unit 9 judges that it is the 3 segment broadcasting, it is possible to stop the operation of the second demodulating unit 8 in order to reduce the power consumption. For example, the supply clock signal to the second demodulating unit 8 is stopped.

Moreover, it is also preferable that the judging unit 9 outputs it to the exterior of the receiving apparatus 1. This is because the output to the outside may be used as a trigger for stopping the power supply to the antenna 3 or the tuner 6. As a result, the power consumption can be further reduced.

As mentioned above, in case of the 3 segment broadcasting, it is possible to reduce the power consumption and perform non-diversity receiving. Comparing to the 1 segment broadcasting, in the 3 segment broadcasting, the quality of reception of non-diversity receiving tends to be better. Thus, it is possible to suppress the increase of the circuit scale, and acquire enough quality of reception in the non-diversity receiving in practice. At this time, it is also possible to suppress the power consumption.

On the other hand, in the non-diversity receiving of the 1 segment broadcasting, it is possible to realize the diversity receiving with the minimum circuit construction and scale, which can also handle the 3 segment broadcasting.

In other words, the receiving apparatus 1 in Embodiment 1 can demodulate both of the 1 segment broadcasting and 3 segment broadcasting whose circuit scale, quality of reception, and power consumption are suitably balanced.

In addition, each element, which constitutes the receiving apparatus 1, may be hardware, software, or the mixture of the hardware and software.

Moreover, the operation of the first demodulating unit 7, the second demodulating unit 8, the combining/selecting unit 10, and the error correcting unit 11 may be realized by the processor corresponding to them, and the program that the processor loads thereon.

First, the processor loads the program related to the receiving processing. Then, the processor receives the OFDM signal received by the antennas 2 and 3 via the tuners 5 and 6. The program is stored in an ROM and/or an RAM, which are/is accessed by the processor.

Next, the processor loads the program related to demodulating, and then demodulates the receiving signal which is received. At this time, there are two steps of: a first demodulating step of demodulating both of the 1 segment broadcasting and the 3 segment broadcasting to output the first carrier group; and a second demodulating step of demodulating the 1 segment broadcasting to output the second carrier group. Next, the receiving signal is judged whether it is the OFDM signal based on the 1 segment broadcasting or the OFDM signal based on the 3 segment broadcasting.

The processor loads the program related to the combining and selecting, and performs the combining and selecting of the first carrier and the second carrier according to the judgment result. In a judging step, when it is judged the OFDM signal, which is being received, is based on the 1 segment broadcasting, the first carrier group and the second carrier group are combined in a combining/selecting step. In the judging step, when it is judged the OFDM signal, which being received, is based on the 3 segment broadcasting, the first carrier group is selected in the combining/selecting step.

As mentioned above, the receiving processing in Embodiment 1 may be realized by the processor and the dedicated program.

### Embodiment 2

Embodiment 2 will now be explained below.

Embodiment 2 explains a receiving apparatus having further reduced circuit scale comparing to the receiving apparatus in Embodiment 1. The receiving apparatus in Embodiment 2 is operable to perform the diversity receiving for the 1 segment broadcasting, and to perform the non-diversity broadcasting for the 3 segment broadcasting by the smallest circuit scale, while the circuit scale, the quality of reception, and the power consumption are suitably balanced.

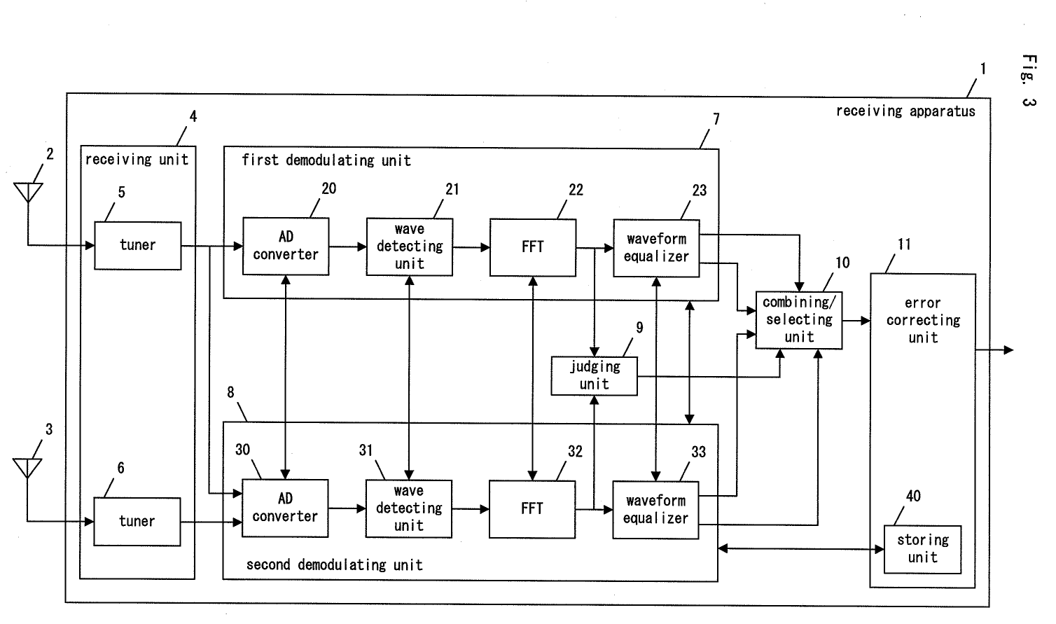

First, the following will now be explained referring to FIG. 3. FIG. 3 is a block diagram of a receiving apparatus according to Embodiment 2 of the present invention.

In addition, the frequency division multiplexing signal broadly includes the communication signal for which a carrier is multiplexed on the frequency axis. In Embodiment 2, the OFDM signal, which is defined by the ISDB-T standard in the digital terrestrial television services of Japan, will now be explained as an example. In addition, not only the OFDM signal, but the communication signal also broadly includes an FDM signal, an SS-OFDM signal, and so on.

Moreover, in the ISDB-T standard in the digital terrestrial television services, 13 segments form one bandwidth by making one segment, which consists of a carrier group of a predetermined number, as a unit. Within this specification, in the ISDB-T standard, the 1 segment broadcasting means that the broadcasting uses one segment of the 13 segments for a mobile terminal or a portable terminal. Similarly, the 3 segment broadcasting means that the broadcasting uses three segments of the same 13 segments.

The receiving apparatus 1 is provided with a receiving unit 4 operable to receive the OFDM signal and output the receiving signal; the first demodulating unit 7 operable to modulate the receiving signal based on the 1 segment broadcasting; the second demodulating unit 8 operable to demodulate the receiving signal based on the 1 segment broadcasting and to output the second carrier group; the judging unit 9; the combining/selecting unit 10 operable to combine or select the first carrier group and the second carrier group; and the error correcting unit 11.

Dissimilar to the receiving apparatus 1 in Embodiment 1, but similar to the second demodulating unit 8, the first demodulating unit 7 performs the demodulating based on the first segment broadcasting, and does not possess the resource corresponding to the demodulating based on the 3 segment broadcasting.

The antennas 2 and 3 and the receiving unit 4 (the tuners 5 and 6 included in the receiving unit 4) possess the same function as that of Embodiment 1, which has been already explained.

The AD converters 20 and 30, the wave detecting units 21 and 31, the FFTs 22 and 32, and the waveform equalizers 23 and 33 possess the same function as that of Embodiment 1, which has been already explained.

However, each of the AD converter 20, the wave detecting unit 21, the FFT 22, and the waveform equalizer 23, which are included in the first demodulating unit 7, possesses the amount of resource corresponding to the 1 segment broadcasting. Similarly, the AD converter 30, the wave detecting unit 31, the FFT 32, and the waveform equalizer 33, which are included in the second demodulating unit 8, possesses the above-mentioned amount of resource.

Moreover, in the 3 segment broadcasting that will be mentioned in the following, each of the elements (the AD converter 20, the wave detecting unit 21, the FFT 22, and the waveform equalizer 23) included in the first demodulating unit 7 performs necessary processing by using the elements (the AD converter 30, the wave detecting unit 31, the FFT 32, and the waveform equalizer 23) if necessary.

Similar to Embodiment 1, the judging unit 9 judges whether the receiving signal is the OFDM signal based on the a segment broadcasting or the OFDM signal based on the 3 segment broadcasting.

The judging unit 9 demodulates a TMCC signal included in the first carrier group and the second carrier group, and performs judgment. Alternatively, the judging unit 9 performs judgment according to the instruction signal from the outside. The judging unit 9 outputs the judgment result to the first demodulating unit 7, the second demodulating unit 8, the combining/selecting unit 10, the error correcting unit 11, and the exterior of the receiving apparatus 1.

As a basic function, the combining/selecting unit 10 and the error correcting unit 11 also possess the same function as explained in Embodiment 1. In addition, the error correcting unit 11 is provided with a storing unit 40 that is used when the error correction is performed. The storing unit 40 temporarily stores a carrier or digital data in rearrangement (for example, changing a position of digital data, which is rearranged by a frequency interleave or a time interleave, to the position where it existed before) of the carrier or digital data, which is performed when the error correction is done.

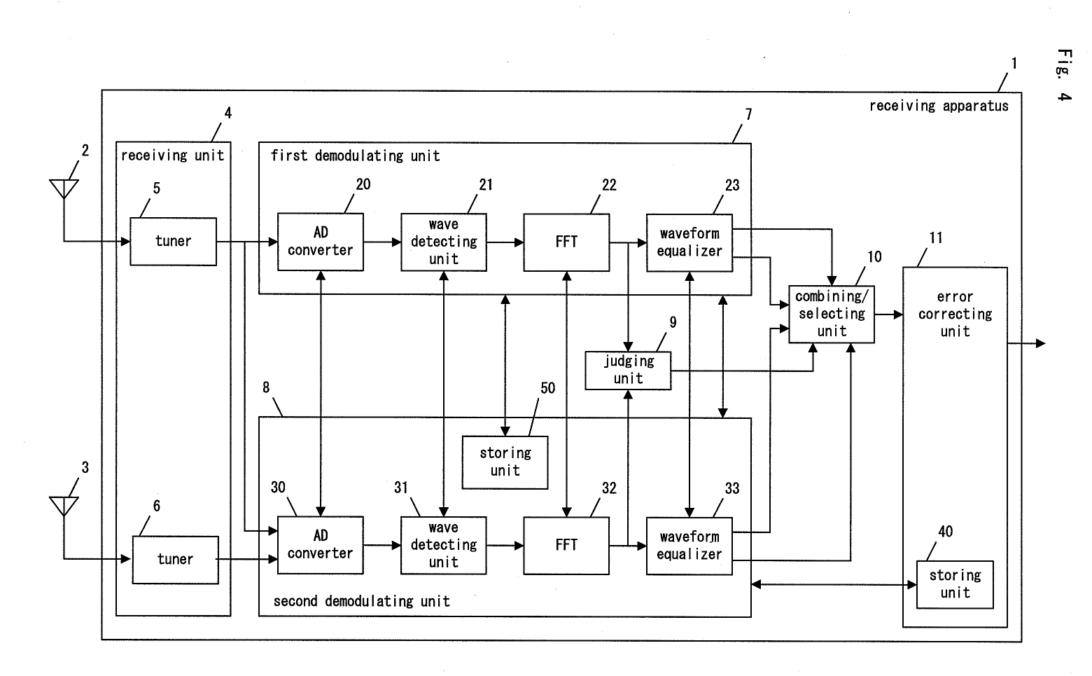

FIG. 4 is a block diagram of the receiving apparatus according to Embodiment 2 of the present invention. Dissimilar to FIG. 3, in the receiving apparatus 1 shown in FIG. 4, the second demodulating unit 8 is provided with a storing unit 50. The storing unit 50 is a storing area used by the second demodulating unit 8 when the demodulating is performed.

Next, receiving operation of the 1 segment broadcasting and the 3 segment broadcasting by the receiving apparatus 1 will now be explained.

(1 Segment Broadcasting)

When the 1 segment broadcasting is performed according to the demodulating of the TMCC signal and the instruction signal from the outside, the judging unit 9 judges that the OFDM signal being received is the 1 segment broadcasting, and notifies each unit of the result.

When it is judged to be the 1 segment broadcasting, the first demodulating unit 7 and the second demodulating unit 8 demodulate the OFDM signal based on the 1 segment broadcasting using the resource (the AD converters 20 and 30, the wave detecting units 21 and 31, the FFTs 22 and 32, and the waveform equalizers 23 and 33), each of which the demodulating unit possesses. According to the demodulating, the first demodulating unit 7 outputs the first carrier group, and the second demodulating unit 8 outputs the second carrier group. Both of the first carrier group and the second carrier group are carrier groups generated by the demodulating corresponding to 1 segment broadcasting.

After receiving the judgment result from the judging unit 9, the combining/selecting unit 10 combines or selects the carrier, each of which the first carrier group and the second carrier group includes. For example, the combining/selecting unit 10 selects a first reliability value calculated by the waveform equalizer 23, and also selects the carrier included in the first carrier group and the carrier included in the second carrier group using a second reliability value calculated by the waveform equalizer 33. Alternatively, the combining/selecting unit 10 performs combining in maximum ratio for the carrier included in the first carrier group and the carrier included in the second carrier group using the first reliability value and the second reliability value. The combining in maximum ratio is the same processing as explained referring to FIG. 2.

Moreover, the combining/selecting unit 10 may perform the combining in equal ratio for the carrier included in the first carrier group and the carrier included in the second carrier group according to predetermined ratio.

In the 1 segment broadcasting, the diversity receiving in such a carrier unit is performed, thereby improving quality of reception.

In addition to the second demodulating unit 8, the receiving apparatus 1 is provided with a third demodulating unit operable to demodulate at least 1 segment broadcasting. At the time of the 1 segment broadcasting, the receiving apparatus 1 may perform the diversity receiving using more than 3 demodulating results (it may be provided with a fourth demodulating unit, the number of which is not limited to this example). This is because, when the number of the branch increases, the quality of reception by the diversity receiving is further improved.

Moreover, in some of the demodulating units, when the quality of reception is very poor in the diversity receiving, it is preferable that the combining/selecting unit 10 does not use the carrier from the concerned receiving unit in order to prevent deterioration of the quality of reception. At this time, it is also preferable to reduce power consumption by stopping supply of clock signals to a demodulating unit whose quality of reception is very poor or by stopping electric power supply thereto.

Although the error correcting unit 11 is provided with the storing unit 40, dissimilar to the 3 segment broadcasting, in the 1 segment broadcasting, since the number of bits for the digital data to be rearranged is small, a storing area possessed by the storing unit 40 may remain. For this reason, it is effective to reduce the circuit scale by performing the demodulating using the remained storing area by the first demodulating unit 7 or the second demodulating unit 8.

(3 Segment Broadcasting)

When the 3 segment broadcasting is performed, the judging unit 9 judges that the OFDM signal being received is the 3 segment broadcasting according to the demodulating of the TMCC signal or the instruction signal from the outside, and notifies each unit of the result.

At the time of the 3 segment broadcasting, the receiving apparatus 1 receives the 3 segment broadcasting using both of the first demodulating unit 7 and the second demodulating unit 8. In other words, the first demodulating unit 7 realizes the receiving and demodulating of the 3 segment broadcasting using the second demodulating unit 8. In this case, the non-diversity receiving is performed in the demodulating of the OFDM signal based on the 3 segment broadcasting.

The antenna 2 and the antenna 3 receive the OFDM signal based on the 3 segment broadcasting. The tuners 5 and 6 receive predetermined bandwidth, and then output the receiving signal to the first demodulating unit 7 and the second demodulating unit 8. Here, in the 3 segment broadcasting, the receiving signal to be outputted from the tuner 5 is inputted into both of the first demodulating unit 7 and the second demodulating unit 8. For the balance with the reduction of the circuit scale, the first demodulating unit 7 can not demodulate the 3 segment broadcasting independently. For this reason, the first demodulating unit 7 performs the demodulating by using the resource (the AD converter 30, wave detecting unit 31, the FFT 32, and the waveform equalizer 33), which the second demodulating unit 8 possesses. By using the second demodulating unit 8, the first demodulating unit 7 realizes the demodulating of the 3 segment broadcasting using the resource, which the receiving apparatus 1 possesses. In other words, only the number of carriers corresponding to the 1 segment broadcasting can be demodulated by the resource of the first demodulating unit 7. However, it is possible to perform the demodulating for the number of carriers corresponding to the 3 segment broadcasting using the resource of the second demodulating unit.

First, as shown in FIG. 3, the first demodulating unit 7 and the second demodulating unit 8 perform the demodulating using the remained storing area of the storing unit 40, with which the error correcting unit 11 is provided.

Moreover, as shown in FIG. 4, the first demodulating unit 7 may perform the demodulating by using the storing unit 50 included in the second demodulating unit 8. In the demodulating of the second demodulating unit 8, the storing unit 50 temporarily stores data. For example, since the storing unit 50 performs the non-diversity receiving, at the time of the 3 segment broadcasting reception, the reliability value for the waveform equalizer 33 does not need to be calculated. For this reason, the storing unit 50, which is used by each element, for example, the waveform equalizer 33, possesses a vacant area at the time of the 3 segment broadcasting reception. The first demodulating unit 7 performs the demodulating by using the vacant area of the storing unit 50 as well as using the resource of the second demodulating unit 8.

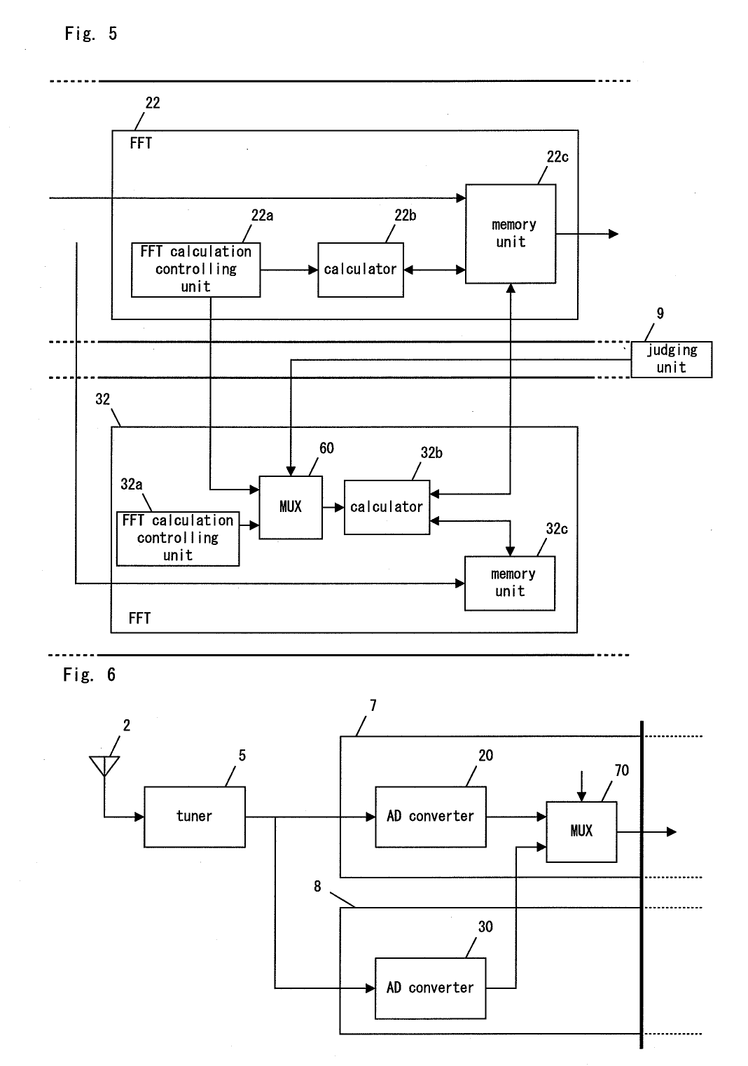

Moreover, as shown in FIG. 5, the demodulating 7 realizes the demodulating for the number of carriers that corresponds to the 3 segment broadcasting by performing time-to-frequency conversion using the FFT 32 included in the second demodulating unit 8. The FFT 22 and the FFT 32 convert the receiving signal of an inputted time axis to a signal of a frequency axis according to a butterfly calculation, respectively, and then demodulate a carrier that is multiplexed by the frequency axis. FIG. 5 is a block diagram illustrating neighborhood of FFT according to Embodiment 2 of the present invention.

The FFT 22 is provided with an FFT calculation controlling unit 22a operable to control the time-to-frequency conversion; a calculator 22b operable to perform necessary butterfly calculation for the time-to-frequency conversion; and a memory unit 22c operable to store a center value or a result value in the calculation. Similarly, the FFT 32 is provided with an FFT calculation controlling unit 32a, a calculator 32b, and a memory unit 32c. In addition, the FFT 32 is provided with a multiplexer (it is shown as “MUX” in the figure) 60.

The FFT 22 included in the first demodulating unit 7 demodulates the number of carriers corresponding to the 3 segment broadcasting by using the FFT 32 included in the second demodulating unit 8. Specifically, at the time of the 3 segment broadcasting, the same receiving signal is inputted into the first demodulating unit 7 and the second demodulating unit 8. The FFT 22 and the FFT 32 perform the time-to-frequency conversion for a part and the remained part of the same receiving signal. The result generated by the FFT 32 performing the time-to frequency conversion is outputted to the memory unit 22c. Then, the demodulated carrier, which is appropriate for the number of carriers corresponding to the 3 segment broadcasting, is outputted from the FFT 22. The FFT 22 and the FFT 32 possess the sampling number, which is at least 1.5 times of the number of carriers corresponding to the 1 segment broadcasting based on the ISFB-T standard. By two FFTs of the FFT 22 and the FFT 32, it is possible to demodulate the number of carriers corresponding to the 3 segment broadcasting.

Next, the AD converter 20 included in the first demodulating unit 7 may perform the analog-to-digital conversion corresponding to the 3 segment broadcasting by using the AD converter 30 included in the second demodulating unit 8.

FIG. 6 is a block diagram illustrating neighborhood of an analog-to-digital converter according to Embodiment 2 of the present invention.

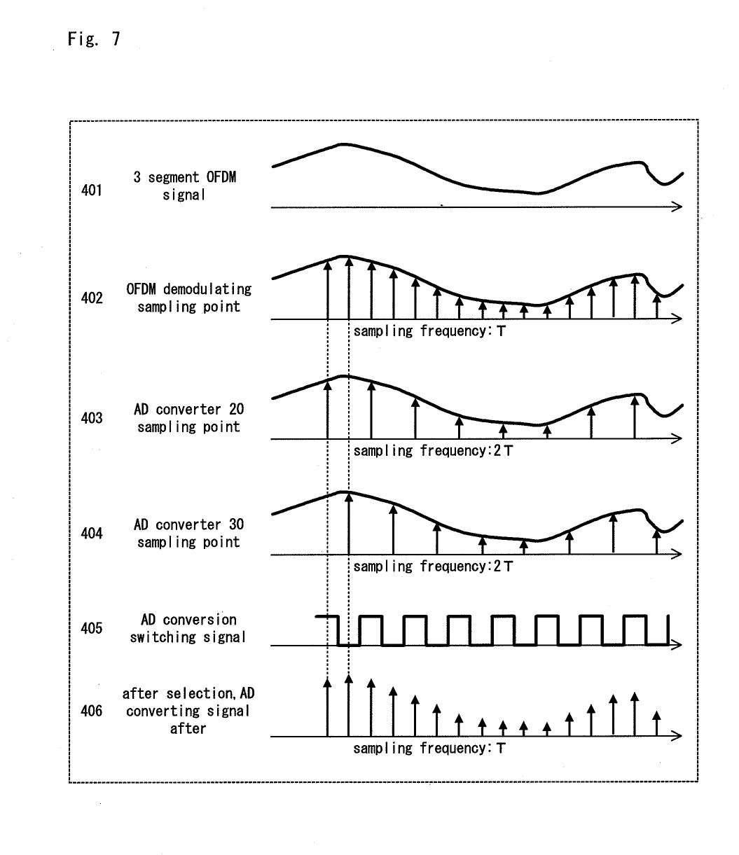

The receiving signal, which is outputted from the tuner 5, is inputted into the analog-to-digital converter 20 included in the first demodulating unit 7 and the analog-to-digital converter 30 included in the second demodulating unit 8. As shown in FIG. 7, each of the analog-to-digital converters 20 and 30 sets up a sampling point at a different point to the same receiving signal, and then performs the analog-to-digital conversion. As a result, by the analog-to-digital converters 20 and 30, it is possible to perform the analog-to-digital conversion for the OFDM signal corresponding to the 3 segment broadcasting.

The analog-to-digital conversion of the OFDM signal corresponding to the 3 segment broadcasting by the two analog-to-digital converters will now be explained referring to FIG. 7. FIG. 7 is a timing chart explaining analog-to-digital conversion according to Embodiment 2 of the present invention.

As shown with a waveform 401, the OFDM signal of the 3 segment broadcasting is inputted from the tuner 5 into each of the analog-to-digital converters 20 and 30. A waveform 402 shows a sampling point that is necessary for the 3 segment broadcasting. As shown with the waveform 402, the necessary sampling point is determined according to a sampling-cycle T.

At this time, each of the analog-to-digital converter 20 and the analog-to-digital converter 30 performs the sampling for a 3 segment signal by 2T, which is a double cycle of the sampling-cycle T. The difference of the sampling points between the analog-to-digital converter 20 and the analog-to-digital converter 30 is the cycle T. Using a switching signal as shown in a waveform 405, a multiplexer 70 outputs the result for which the analog-to-digital converter 20 performed the sampling, and then the result for which the analog-to-digital converter 30 performed the sampling.

As shown with a waveform 406, by the above-mentioned processing, it is possible to realize the analog-to-digital conversion by the sampling point that is necessary for the demodulating of the 3 segment broadcasting.

As mentioned above, the first demodulating unit 7 realizes the demodulating of the OFDM signal based on the 3 segment broadcasting by using each element (then analog-to-digital converter 30, the wave detecting unit 31, the FFT 32, and the waveform equalizer 33) that is included in the second demodulating unit 8. Since each of the first demodulating unit 7 and the second demodulating unit 8 possesses the resource corresponding to the 1 segment broadcasting, the circuit scale as the entire of the receiving apparatus 1 is small. Of course, power consumption thereof is also low.

The first carrier group, in which the first demodulating unit 7 performed the demodulating by using the resource of the second demodulating unit 8, possesses the number of carriers corresponding to the 3 segment broadcasting. The combining/selecting unit 10 selects the first carrier group, and outputs it to the error correcting unit 11.

At the time of the 1 segment broadcasting, the receiving apparatus 1 in Embodiment 2 performs the diversity receiving operable to improve the quality of reception. At the time of the 3 segment broadcasting, the receiving apparatus 1 in Embodiment 2 can perform the non-diversity receiving with the minimum circuit scale. In particular, comparing to the receiving apparatus 1 in Embodiment 1, the receiving apparatus 1 in Embodiment 2 can demodulate the OFDM signal based on the 3 segment broadcasting with the smaller circuit scale.

In addition, the receiving apparatus 1 may be provided with a third demodulating unit operable to perform demodulating of the 1 segment broadcasting, and demodulate the OFDM signal based on the 3 segment broadcasting by using the three demodulating units of the first demodulating unit 7, the second demodulating unit 8, and the third demodulating unit (it is operable to demodulate the OFDM signal based on the 1 segment broadcasting).

When the demodulating of the 3 segment broadcasting is realized by using a plurality of demodulating units corresponding to the demodulating of the 1 segment broadcasting, the first demodulating unit 7 may demodulate by using the resource of other demodulating unit, gathering the carriers for the number corresponding to the 3 segment broadcasting, and outputting it to the combining/selecting unit 10. In addition, the combining/selecting unit 10 may combine the first carrier outputted from the first demodulating unit 7, the second carrier outputted from the second demodulating unit 8, and the third carrier outputted from the third demodulating unit, and then may output the carrier corresponding to the number of carriers for the 3 segment broadcasting.

In addition, the receiving apparatus 1 may be provided with a various kinds of electric devices using a frequency division multiplexing signal, for example, an OFDM signal.

The electric devices may be, for example, a car navigation system, a television device built in a car, a cellular phone, a portable terminal, a PDA, and a non-portable electric device, a non-portable television, a DVD player, a personal computer, a radio, a VTR, or the like.

These electric devices can display an image or reproduce a sound by receiving and demodulating the frequency division multiplexing signal including demodulated visual or audio information. Users can enjoy a displayed image and/or reproduced sound.

Thus, when the receiving apparatus of the present invention is provided with an electric device, it is possible to receive the 1 segment broadcasting in the digital terrestrial television service with high quality, and to receive the 3 segment broadcasting with a small circuit scale.

### INDUSTRIAL APPLICABILITY

The present invention can be preferably used, for example, in a field of a receiving apparatus which is included in a portable terminal or a movable terminal for receiving digital terrestrial television services.

1. A receiving apparatus comprising:
a receiving unit operable to receive a frequency division multiplexing signal to output a receiving signal;
a first demodulating unit operable to demodulate the receiving signal based on one of 1 segment broadcasting and 3 segment broadcasting to output a first carrier group;
a second demodulating unit operable to demodulate the receiving signal based on the 1 segment broadcasting to output a second carrier group;
a judging unit operable to judge one of a first judgment result and a second judgment result, the first judgment result indicating that the receiving signal includes the frequency division multiplexing signal based on the 1 segment broadcasting, the second judgment result indicating that the receiving signal includes the frequency division multiplexing signal based on the 3 segment broadcasting; and
a combining/selecting unit operable to perform at least one of combining the first carrier group with the second carrier group, and selecting one of the first carrier group and the second carrier group,
wherein in case of the first judgment result, said combining/selecting unit performs one of combining the first carrier group with the second carrier group then outputting a combined carrier, and selecting one of the first carrier group and the second carrier group then outputting a selected carrier, and
wherein in case of the second judgment result, said combining/selecting unit performs selecting the first carrier group.

2. A receiving apparatus as defined in claim 1, wherein said judging unit performs judgment according to an instruction signal from the exterior.

3. A receiving apparatus as defined in claim 1, wherein said judging unit performs judgment according to a TMCC signal demodulated by at least one of said first demodulating unit and said second demodulating unit.

4. A receiving apparatus as defined in claim 1, wherein said judging unit output a judgment result to the exterior.

5. A receiving apparatus as defined in claim 1, wherein said combining/selecting unit combines the first carrier group with the second carrier group, in maximum ratio according to a predetermined reference value.

6. A receiving apparatus as defined in claim 1, wherein at least one of said first demodulating unit and said second demodulating unit comprises:
an analog-to-digital converter operable to digitize the receiving signal;
a wave detecting unit operable to detect a signal outputted by said analog-to-digital converter; and
a time-to-frequency mapping unit operable to map a signal outputted by said wave detecting unit from a signal along a time axis to a signal along a frequency axis.

7. A receiving apparatus comprising:
a receiving unit operable to receive a frequency division multiplexing signal to output a receiving signal;
a first demodulating unit operable to demodulate the receiving signal based on 1 segment broadcasting to output a first carrier group;
a second demodulating unit operable to demodulate the receiving signal based on the 1 segment broadcasting to output a second carrier group;
a judging unit operable to judge one of a first judgment result and a second judgment result, the first judgment result indicating that the receiving signal includes the frequency division multiplexing signal based on the 1 segment broadcasting, the second judgment result indicating that the receiving signal includes the frequency division multiplexing signal based on 3 segment broadcasting;
a combining/selecting unit operable to perform at least one of combining the first carrier group with the second carrier group, and selecting one of the first carrier group and the second carries group; and
an error correcting unit operable to perform error correction with respect to a signal outputted by said combining/selecting unit,
wherein in case of the first judgment result, said first demodulating unit and said second demodulating unit demodulates the receiving signal based on the 1 segment broadcasting, respectively, and said combining/selecting unit performs one of combining the first carrier group with the second carrier group then outputting a combined carrier, and selecting one of the first carrier group and the second carries group then outputting selected carrier, and
wherein in case of the second judgment result, said first demodulating unit demodulates the receiving signal based on the 3 segment broadcasting with the use of said second demodulating unit.

8. A receiving apparatus as defined in claim 7, wherein each of said first demodulating unit and said second demodulating unit comprises:
an analog-to-digital converter operable to digitize the receiving signal;
a wave detecting unit operable to detect a signal outputted by said analog-to-digital converter; and
a time-to-frequency mapping unit operable to map a signal outputted by said wave detecting unit from a signal along a time axis into a signal along a frequency axis,
wherein said time-to-frequency mapping unit possesses sampling numbers not less than the product of one point five and sampling numbers necessary for 1 segment broadcasting,
wherein, when said judging unit judges that the receiving signal is the frequency division multiplexing signal based ion the 3 segment broadcasting, said first demodulating unit demodulates the receiving signal based on the 3 segment broadcasting, with the use of said time-to-frequency converting unit possessed by said second demodulating unit.

9. A receiving apparatus as defined in claim 7, wherein in case of the second judgment result, said first demodulating unit demodulates the receiving signal based on the 3 segment broadcasting, with the use of said analog-to-digital converter possessed by said second demodulating unit.

10. A receiving apparatus as defined in claim 7, wherein said error correcting unit comprises a storing unit, and
wherein in case of the second judgment result, said first demodulating unit demodulates the receiving signal based on the 3 segment broadcasting, with the use of said storing unit possessed by said error correcting unit.

11. A receiving apparatus as defined in claim 7, wherein said second demodulating unit comprises a storing unit, and
wherein in case of the second judgment result, said first demodulating unit demodulates the receiving signal based on the 3 segment broadcasting, with the use of said storing unit possessed by said second demodulating unit.

12. A receiving apparatus as defined in claim 7, further comprising:
a third demodulating unit operable to demodulate the receiving signal based on the 3 segment broadcasting to output a third carrier group,
wherein in case of the first judgment result, said first demodulating unit, second demodulating unit, and third demodulating unit demodulates the receiving signal based on the 1 segment broadcasting, respectively, and said combining/selecting unit combines the first carrier group, the second carrier group, and the third carrier group then outputs a combined carrier, and
wherein in case of the second judgment result, said first demodulating unit demodulates the receiving signal based on the 3 segment broadcasting, with the use of said second demodulating unit and said third demodulating unit.

13. A receiving apparatus as defined in claim 7, wherein said judging unit performs judgment according to an instruction signal from the exterior.

14. A receiving apparatus as defined in claim 7, wherein said judging unit performs judgment according to a TMCC signal demodulated by at least one of said first demodulating unit and said second demodulating unit.

15. A receiving apparatus as defined in claim 7, wherein said combining/selecting unit combines the first carrier group with the second carrier group, in maximum ratio according to a predetermined reference value.

16. A receiving apparatus as defined in claim 1, wherein the frequency division multiplexing signal includes an OFDM signal.

17. A receiving apparatus as defined in claim 1, wherein the 1 segment broadcasting and the 3 segment broadcasting are televised by digital terrestrial television services based on the OFDM signal.

18. A receiving method comprising:
a receiving step of receiving a frequency division multiplexing signal to output a receiving signal;
a first demodulating step of demodulating the receiving signal based on one of 1 segment broadcasting and 3 segment broadcasting to output a first carrier group;
a second demodulating step of demodulating the receiving signal based on the 1 segment broadcasting to output a second carrier group;
a judging step of judging one of a first judgment result and a second judgment result, the first judgment result indicating that the receiving signal includes the frequency division multiplexing signal based on the 1 segment broadcasting, the second judgment result indicating that the receiving signal includes the frequency division multiplexing signal based on the 3 segment broadcasting; and
a combining/selecting step of performing at least one of combining the first carrier group with the second carrier group, and selecting one the first carrier group and the second carrier group,
wherein in case of the first judgment result, said combining/selecting step includes combining the first carrier group with the second carrier group and outputting a combined carrier, and
wherein in case of the second judgment result, said combining/selecting step includes selecting the first carrier group and outputting a selected carrier.
